(19) United States
(12) Patent Application Publication
(10) Pub. No.: US 2011/0194093 A1
(43) Pub. Date: Aug. 11, 2011

(54) POLARIZATION-INFLUENCING OPTICAL ARRANGEMENT AND AN OPTICAL SYSTEM OF A MICROLITHOGRAPHIC PROJECTION EXPOSURE APPARATUS

(75) Inventor: Ingo Saenger, Heidenheim (DE)

(73) Assignee: CARL ZEISS SMT GMBH, Oberkochen (DE)

(21) Appl. No.: 13/021,345

(22) Filed: Feb. 4, 2011

Related U.S. Application Data
(60) Provisional application No. 61/302,249, filed on Feb. 8, 2010.

(30) Foreign Application Priority Data
Feb. 8, 2010 (DE) 10 2010 001 658.6

(51) Int. Cl. G03B 27/72; G02B 5/30; G03B 27/32

(52) U.S. Cl. 355/71; 359/489.01; 355/77

(57) ABSTRACT

A polarization-influencing optical arrangement includes a pair, which includes a first lambda/2 plate and a second lambda/2 plate. The first and second lambda/2 plates partially overlap each other forming an overlap region and at least one non-overlap region.

### CROSS-REFERENCE TO RELATED APPLICATIONS

This application claims priority under 35 U.S.C. §119(e)(1) to U.S. Provisional Application No. 61/302,249 filed Feb. 8, 2010. This application also benefit under 35 U.S.C. §119 to German Application No. 10 2010 001 658.6, filed Feb. 8, 2010. The entire contents of both of these applications are incorporated by reference herein.

### FIELD

The disclosure concerns a polarization-influencing optical arrangement and an optical system of a microlithographic projection exposure apparatus, in particular an illumination system or a projection objective. In particular the disclosure concerns a polarization-influencing optical arrangement which permits enhanced flexibility in the provision of a desired polarization distribution.

### BACKGROUND

Microlithography is used for the production of microstructured components such as for example integrated circuits or LCDs. The microlithography process is carried out in what is referred to as a projection exposure apparatus having an illumination system and a projection objective. The image of a mask illuminated via the illumination system (reticle) is in that case projected via the projection objective on to a substrate (for example a silicon wafer) which is coated with a light-sensitive layer (photoresist) and arranged in the image plane of the projection objective to transfer the mask structure on to the light-sensitive coating on the substrate.

Various approaches are known for setting certain polarization distributions in the pupil plane and/or in the reticle in specifically targeted fashion in the illumination system for optimizing the imaging contrast. In particular it is known both in the illumination system and also in the projection objective to set a tangential polarization distribution for high-contrast imaging. The term ‘tangential polarization’ (or ‘TE polarization’) is used to denote a polarization distribution in which the planes of vibration of the electrical field strength vectors of the individual linearly polarized light beams are oriented approximately perpendicularly with respect to the radius directed on to the optical system axis. In contrast the term ‘radial polarization’ (or ‘TM polarization’) is used to denote a polarization distribution in which the planes of vibration of the electrical field strength vectors of the individual linearly polarized light beams are oriented approximately radially with respect to the optical system axis.

WO 2005/069081 A2 discloses a polarization-influencing optical element which includes an optically active crystal and has a thickness profile that varies in the direction of the optical axis of the crystal.

It is known, for example, from U.S. Pat. No. 6,392,800, for the conversion of an entering light beam into an exiting light beam with light linearly polarized in substantially a radial direction in the entire cross-section, to use a stress birefringence quarter-wave plate which is subjected to radial pressure stress in combination with a circularly birefringent plate which rotates the polarization direction through 45°, possibly with the upstream arrangement of a normal quarter-wave plate.

It is known, for example, from WO 2006/077849 A1 to arrange an optical element in a pupil plane of an illumination system or in the proximity of the pupil plane, for conversion of the polarization state, where the optical element has a multiplicity of variable optical rotator elements, by which the polarization direction of incident linearly polarized light can be rotated with a variably adjustable angle of rotation.

WO 2005/031467 A2 discloses, in a projection exposure apparatus, influencing the polarization distribution via one or more polarization manipulator devices which can also be arranged at a plurality of positions and can be in the form of polarization-influencing optical elements which can be introduced into the beam path, wherein the action of those polarization-influencing elements can be varied by altering the position, for example rotation, decentering or tilting of the elements.

### SUMMARY OF THE DISCLOSURE

The disclosure provides a polarization-influencing optical arrangement and an optical system of a microlithographic projection exposure apparatus, which permit enhanced flexibility in the provision of a desired polarization distribution.

A polarization-influencing optical arrangement can include include at least one pair including a first lambda/2 plate and a second lambda/2 plate. The first and second lambda/2 plates partially overlap each other forming an overlap region and at least one non-overlap region.

The configuration according to the disclosure of the polarization-influencing optical arrangement makes it possible using partial illumination of different regions of the arrangement to flexibly set mutually different polarized illumination settings without the polarization-influencing optical arrangement having to be replaced or changed with respect to its position for the change between those illumination settings. The disclosure is therefore based on the concept of providing, by partial overlap of two lambda/2 plates, at least two regions which, when light passes therethrough, produce mutually different exit polarization distributions that depend on whether the light passes through only one of the lambda/2 plates, through both lambda/2 plates or through none of the lambda/2 plates.

The flexible setting of different illumination settings, which is made possible in that way in a projection exposure apparatus, can be achieved in particular without the need for additional optical components, which reduces structural complication and expenditure as well as the costs for example for a lithography process. In addition, this avoids a transmission loss that is involved in the use of additional optical components.

In an embodiment the overlap region is arranged between a first non-overlap region in which there is only the first lambda/2 plate and a second non-overlap region in which there is only the second lambda/2 plate.

The overlap region and the at least one non-overlap region can each have in particular a respective geometry in the shape of a segment of a circle. In that case the segment of a circle forming the overlap region can have a different opening angle from the segment of the circle forming the at least one non-overlap region.

In an embodiment the first lambda/2 plate has a first fast axis of the birefringence and the second lambda/2 plate has a second fast axis of the birefringence, wherein the first fast axis and the second fast axis are arranged at an angle of 45°±5° relative to each other.

In an embodiment a plane of vibration of a first linearly polarized light beam incident on the arrangement in the overlap region is rotated through a first angle of rotation and a plane of vibration of a second linearly polarized light beam incident on the arrangement in the at least one non-overlap region is rotated through a second angle of rotation, where the first angle of rotation is different from the second angle of rotation.

In an embodiment the plane of vibration of a second linearly polarized light beam which passes only through the first lambda/2 plate and the plane of vibration of a third linearly polarized light beam which passes through only the second lambda/2 plate are rotated through a second and a third angle of rotation respectively, where the second angle of rotation is different from the third angle of rotation.

In an embodiment the second angle of rotation and the third angle of rotation are the same in magnitude and are of opposite signs.

In an embodiment the first lambda/2 plate and the second lambda/2 plate form a 90° rotator in the overlap region with each other.

In an embodiment the arrangement according to the disclosure has two pairs each including a respective first lambda/2 plate and a respective second lambda/2 plate, wherein the first pair and the second pair are arranged on mutually opposite sides of an axis of symmetry of the arrangement.

In a further aspect the disclosure concerns an optical system of a microlithographic projection exposure apparatus including a polarization-influencing optical arrangement according to the disclosure, wherein the polarization-influencing optical arrangement is so arranged in the optical system that both the overlap region and also the at least one non-overlap region are arranged at least partially within the optically effective region of the optical system.

In an embodiment the polarization-influencing optical arrangement in operation of the optical system converts a linear polarization distribution with a preferred polarization direction that is constant over the light beam cross-section of a light beam incident on the arrangement into an approximately tangential polarization distribution.

In an embodiment the first lambda/2 plate has a first fast axis of birefringence which extends at an angle of 22.5°±2° relative to the preferred polarization direction of a light beam incident on the arrangement and the second lambda/2 plate has a second fast axis of birefringence which extends at an angle of −22.5°±2° relative to the preferred polarization direction of a light beam incident on the arrangement.

The disclosure further concerns a microlithographic projection exposure apparatus and a process for the microlithographic production of microstructured components.

Further configurations of the disclosure are to be found in the description and the appendant claims.

### BRIEF DESCRIPTION OF THE DRAWINGS

The disclosure is described in greater detail hereinafter by embodiments illustrated in the accompanying drawings, in which:

FIG. 1 shows a diagrammatic view to illustrate the structure of a microlithographic projection exposure apparatus having a polarization-influencing optical arrangement in accordance with an embodiment of the disclosure,

FIG. 2 shows a diagrammatic view to illustrate the structure of a polarization-influencing optical arrangement in accordance with a specific embodiment of the disclosure,

FIGS. 3a-d show diagrammatic views to illustrate the mode of operation of the polarization-influencing optical arrangement of FIG. 2, and

FIGS. 4, 5a and 5b show diagrammatic views to illustrate different possible uses of the polarization-influencing optical arrangement of FIG. 2.

### DETAILED DESCRIPTION OF PREFERRED EMBODIMENTS

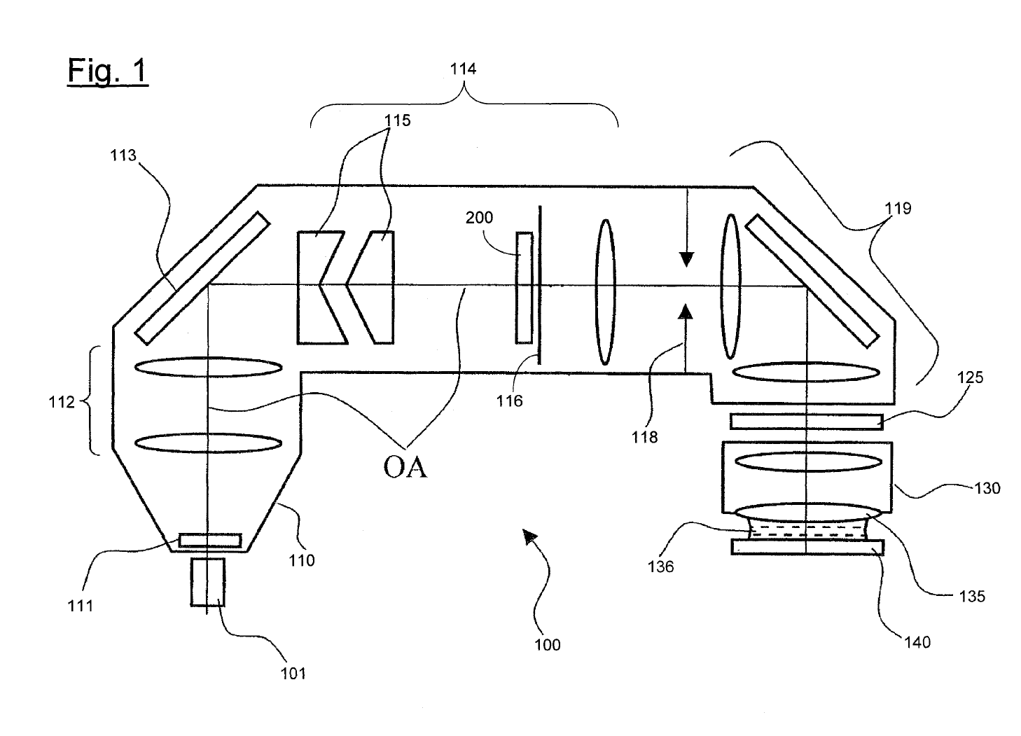

FIG. 1 shows a diagrammatic view of a microlithographic projection exposure apparatus 100 having a light source unit 101, an illumination system 110, a mask 125 having structures to be imaged, a projection objective 130 and a substrate 140 to be exposed. The light source unit 101 includes as its light source a DUV or a VUV laser, for example an ArF laser for 193 nm, an F₂ laser for 157 nm, an Ar₂ laser for 126 nm or an Ne₂ laser for 109 nm, and a beam forming optical mechanism producing a parallel light beam. The rays of the light beam have a linear polarization distribution, wherein the planes of vibration of the electrical field vector of the individual light rays extend in a unitary direction.

The parallel light beam is incident on a divergence-increasing optical element 111. The divergence-increasing optical element 111 can be for example a raster plate of diffractive or refractive raster elements. Each raster element produces a pencil of rays, the angular distribution of which is determined by the extent and focal length of the raster element. The raster plate is disposed in the object plane of a subsequent objective 112 or in the proximity thereof. The objective 112 is a zoom objective which produces a parallel light beam of variable diameter. The parallel light beam is directed by a direction-changing mirror 113 on to an optical unit 114 which includes an axicon 115. Different illumination configurations are produced by the zoom objective 112 in conjunction with the axicon 115 in a pupil plane 116 depending on the respective zoom setting and position of the axicon elements.

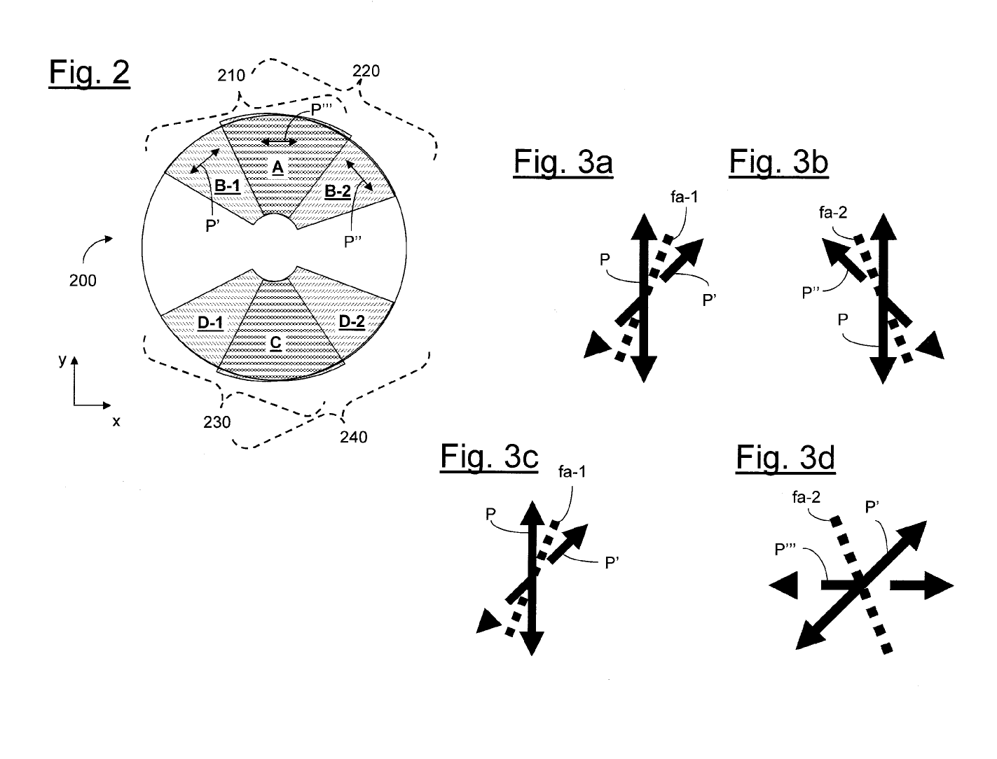

Disposed in the pupil plane 116 or in the immediate proximity thereof is a polarization-influencing optical arrangement 200, the structure and mode of operation of which are described hereinafter with reference to FIGS. 2 through 5. The optical unit 114 is followed by a reticle masking system (REMA) 118 which is imaged by an REMA objective 119 on to the structure-bearing mask (reticle) 125 and thereby delimits an illuminated region on the reticle 125. The structure-bearing mask 125 is imaged with the projection objective 130 on to the light-sensitive substrate 140. In this example disposed between a last optical element 135 of the projection objective 130 and the light-sensitive substrate 140 is an immersion liquid 136 with a refractive index different from air.

Although the polarization-influencing optical arrangement 200 shown in FIG. 1 is used in the illumination system, use in the projection objective is also possible in further embodiments.

FIG. 2 shows a diagrammatic view of the polarization-influencing optical arrangement 200 in accordance with an embodiment of the disclosure.

The polarization-influencing optical arrangement 200 in the illustrated embodiment includes two pairs of respectively partially mutually overlapping lambda/2 plates 210, 220 and 230, 240, wherein those plates are provided on mutually opposite sides of an axis of symmetry of the arrangement 200 (the axis of symmetry extends in the horizontal direction or the x-direction in FIG. 2), and of a mutually similar structure so that hereinafter for the sake of greater ease of description reference is only made to the first pair of lambda/2 plates 210, 220.

The lambda/2 plates 210, 220 are each made from a suitable birefringent material of a transparency which is sufficient at the desired working wavelength, for example crystalline quartz (SiO₂) or magnesium fluoride (MgF₂) and are each of a geometry in the shape of a segment of a circle, wherein in the embodiment as indicated the respective segments of the circle each involve an opening angle of 90°. In that respect the partial overlapping in the FIG. 2 example is so selected that the overlap region identified by ‘A’ extends over an opening angle of 60° (generally preferably 60°±20°, in particular 60°±10°), whereas the non-overlap regions ‘B-1’ and ‘B-2’ provided on both sides of that overlap region ‘A’ each extend over an opening angle of 30° (generally preferably 30°±10°, in particular 30°±5°). It will be appreciated however that the disclosure is not limited to the specified specific opening angle or opening angle ranges so that other opening angles can also be selected depending on the respective desired illumination settings to be implemented.

FIG. 2 also shows, for the situation involving incoming radiation of linearly polarized light with a constant preferred polarization direction P extending in the y-direction, the preferred polarization directions which are afforded in each case after the light passes through the polarization-influencing optical arrangement 200. In that case the respectively resulting preferred polarization direction for the first non-overlap region ‘B-1’ (that is to say the region only covered by the first lambda/2 plate 210) is denoted by P′, for the second non-overlap region ‘B-2’ (that is to say the region only covered by the second lambda/2 plate 220) it is denoted by P″ while for the overlap region ‘A’ (that is to say the region covered both by the first lambda/2 plate 210 and also the second lambda/2 plate 220) it is denoted by P′″.

The occurrence of the respective preferred polarization directions in the above-indicated regions is diagrammatically shown in FIGS. 3a-d, wherein the respective position of the fast birefringent axis (which extends in the direction of a high refractive index) for the first lambda/2 plate 210 is indicated by the broken line ‘fa-1’ and for the second lambda/2 plate 220 by the broken line ‘fa-2’. In the illustrated embodiment the fast axis ‘fa-1’ of the birefringence of the first lambda/2 plate 210 extends at an angle of 22.5°±2° relative to the preferred polarization direction P of the light beam incident on the arrangement 200, and the fast axis ‘fa-2’ of the birefringence of the second lambda/2 plate 220 extends at an angle of −22.5°±2° relative to the preferred polarization direction P of the light beam incident on the arrangement 200.

The preferred polarization direction P′ which is afforded after the light passes through the first lambda/2 plate 210 corresponds to mirroring of the original (entering) preferred polarization direction P at the fast axis ‘fa-1’ (see FIG. 3a) and the preferred polarization direction P″ after the light passes through the second lambda/2 plate 220 corresponds to mirroring of the original (entering) preferred polarization direction P at the fast axis ‘fa-2’ (see FIG. 3b). The preferred polarization directions P′ and P″ respectively after light passes through the non-overlap regions ‘B-1’ and ‘B-2’ consequently extend at an angle of ±45° relative to the preferred polarization direction P of the light beam incident on the arrangement 200.

For the light beam incident on the arrangement 200 in the overlap region ‘A’, the preferred polarization direction P′ of the light beam exiting from the first lambda/2 plate 210 (see FIG. 3c) corresponds to the entry polarization distribution of the light beam incident on the second lambda/2 plate 220 so that the preferred polarization direction referenced P′″ in FIG. 3d of the light beam exiting from the overlap region ‘A’ extends at an angle of 90° relative to the preferred polarization direction P of the light beam incident on the arrangement 200.

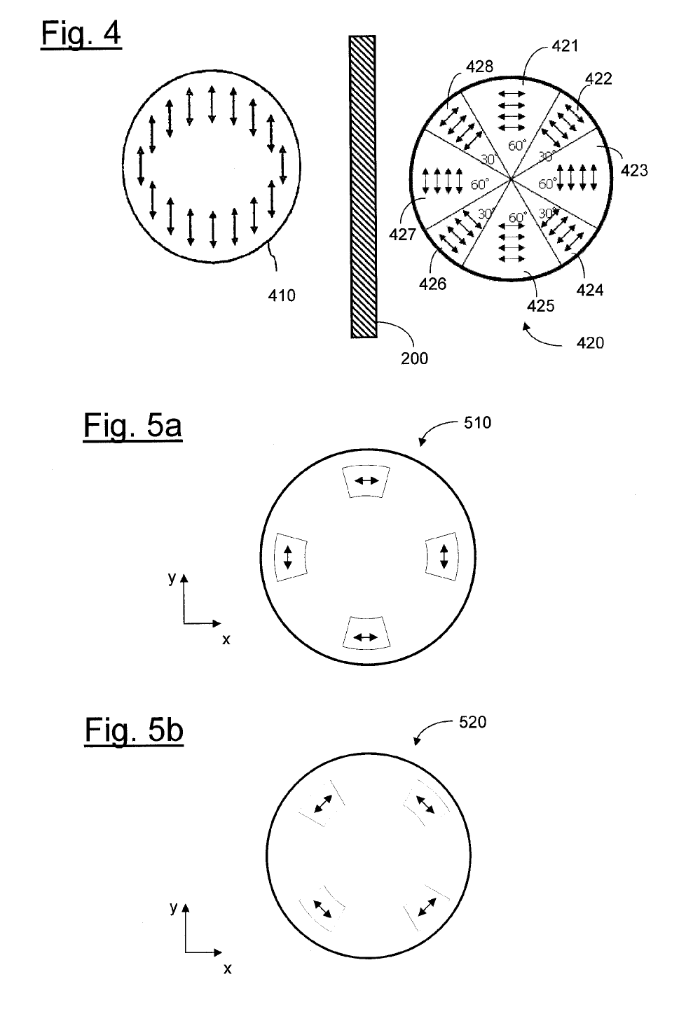

FIG. 4 shows the polarization distribution 420 occurring after light passes through the arrangement 200, for the situation where the entire optically effective area of the arrangement 200 is illuminated with light involving the polarization distribution 410 shown in FIG. 4, of a constantly linear preferred polarization direction.

The polarization distribution 420 is a quasi-tangential polarization distribution with eight regions 421-428 in the shape of a segment of a circle, in which the preferred polarization direction respectively extends constantly and at least approximately tangentially, that is to say perpendicularly to the radius directed towards the optical axis OA.

As none of the lambda/2 plates 210, 220 or 230, 240 is arranged in the regions 423 and 427 of the polarization distribution 420 occurring after light passes through the arrangement 200 there the preferred polarization direction corresponds to the original preferred polarization direction and thus extends in the y-direction.

Flexible setting of different polarization distributions, which is possible in connection with the polarization-influencing optical arrangement according to the disclosure, will be clear by reference to FIGS. 5a-b.

Thus both the quadrupole illumination setting 510 shown in FIG. 5a with a quasi-tangential polarization distribution or the quadrupole illumination setting 520 which is shown in FIG. 5b and which is rotated about the optical axis OA through 45° in relation to FIG. 5a (the so-called ‘quasar illumination setting’) with an also quasi-tangential polarization distribution can be produced by partial illumination either exclusively of the regions 421, 423, 425 and 427 in FIG. 4 or only of the regions 422, 424, 426 and 428 in FIG. 4, without the polarization-influencing optical arrangement 200 having to be exchanged or altered in its position for the change between those two illumination settings.

The change between the two illumination settings 510 and 520, which is possible using the arrangement 200 according to the disclosure, has in particular the advantage that with the arrangement 200 for example production processes carried out hitherto, which have been optimised to the quasi-tangential illumination setting 510 by the OPC method (OPC=optical proximity correction) can be further implemented, but in addition the illumination setting 520 (with a quasi-tangential polarization distribution in illumination poles rotated through 45°) can also be used.

In accordance with further embodiments (not shown) a 90° rotator can be arranged in the beam path in addition to the polarization-influencing optical arrangement 200, with the result that, instead of the above-described quasi-tangential polarization distribution 420, 510 and 520 of FIGS. 4, 5a and 5b, quasi-radial exiting polarization distributions can be correspondingly produced, in which the preferred polarization direction or direction of vibration of the electrical field strength vector extends in the corresponding positions radially, that is to say parallel to the radius directed towards the optical axis OA. That 90° rotator can alternatively be arranged in the light propagation direction upstream or also downstream of the polarization-influencing optical arrangement 200 and provides in known manner that the plane of vibration of the electrical field strength vector of each individual linearly polarized light ray of the beam is rotated through 90°. A possible configuration of that 90° rotator involves providing a plane-parallel plate of an optically active crystal in the beam path, the thickness of which is about 90°/αₚ, wherein αₚ specifies the specific rotational capability of the optically active crystal. A further possible configuration of the 90° rotator involves composing the 90° rotator from two lambda/2 plates of birefringent crystal.

Even if the disclosure has been described by specific embodiments numerous variations and alternative embodiments will be apparent to the man skilled in the art, for example by the combination and/or exchange of features of individual embodiments. Accordingly the man skilled in the art will appreciate that such variations and alternative embodiments are also embraced by the present disclosure and the scope of the disclosure is limited only in the sense of the accompanying claims and equivalents thereof.

What is claimed is:

1. An arrangement, comprising:
a first lambda/2 plate; and
a second lambda/2 plate;
wherein:
the first and second lambda/2 plates partially overlap each other to provide an overlap region and a non-overlap region.

2. The arrangement of claim 1, wherein:
the first and second lambda/2 plates provide first and second non-overlap regions;
the overlap region is between the first and second non-overlap regions;
the first lambda/2 plate is in the first non-overlap region;
the second lambda/2 plate is not in the first non-overlap region;
the second lambda/2 plate is in the second non-overlap region; and
the first lambda/2 plate is not in the first non-overlap region.

3. The arrangement of claim 1, wherein the overlap region is in the shape of a segment of a circle, and the non-overlap region is in the shape of a segment of a segment of a circle.

4. The arrangement of claim 3, wherein the segment of the overlap region has a different opening angle from an opening angle of the segment of the non-overlap region.

5. The arrangement of claim 1, wherein:
the first lambda/2 plate has a first fast axis of the birefringence;
the second lambda/2 plate has a second fast axis of the birefringence; and
the first and second fast axes are arranged at an angle of 45°±5° relative to each other.

6. The arrangement of claim 1, wherein the arrangement is configured so that during use:
a plane of vibration of a first linearly polarized light beam incident on the arrangement in the overlap region is rotated through a first angle of rotation;
a plane of vibration of a second linearly polarized light beam incident on the arrangement in the non-overlap region is rotated through a second angle of rotation; and
the first angle of rotation is different from the second angle of rotation.

7. The arrangement of claim 6, wherein the arrangement is configured so that during use:
the second linearly polarized light beam passes through the first lambda/2 plate;
the second linearly polarized light beam does not pass through the second lambda/2 plate;
a third linearly polarized light beam passes through the second lambda/2 plate;
the third linearly polarized light beam does not pass through the first lambda/2 plate;
a plane of vibration of the third linearly polarized light beam is rotated through a third angle of rotation; and
the second angle of rotation is different from the third angle of rotation.

8. The arrangement of claim 7, wherein the second and third angles of rotation have the same magnitude but opposite sign.

9. The arrangement of claim 1, wherein the first and second lambda/2 plates form a 90° rotator in the overlap region.

10. The arrangement of claim 1, further comprising third and fourth lambda/2 plates,
wherein:
the first and second lambda/2 plates are arranged on a first side of an axis of symmetry of the arrangement;
the third and fourth lambda/2 plates are arranged on a second side of the axis of symmetry of the arrangement; and
the first side of the axis of symmetry of the arrangement is opposite the second side of the axis of symmetry of the arrangement.

11. An optical system, comprising:
an arrangement according to claim 1,
wherein the optical system is configured to be used in a microlithographic projection exposure apparatus.

12. The optical system of claim 11, wherein the arrangement is configured so that the overlap and non-overlap regions are at least partially within an optically effective region of the optical system.

13. The optical system of claim 11, wherein, during use of the optical system, the arrangement converts a light beam incident on the arrangement and having a linear polarization distribution with a preferred polarization direction that is constant over a cross-section of the light beam into an approximately tangential polarization distribution.

14. The optical system of claim 11, wherein the arrangement is configured so that during use of the optical system:
the first lambda/2 plate has a first fast axis of birefringence which extends at an angle of 22.5°±2° relative to a preferred polarization direction of a light beam incident on the arrangement; and
the second lambda/2 plate has a second fast axis of birefringence which extends at an angle of −22.5°±2° relative to the preferred polarization direction of the light beam incident on the arrangement.

15. The optical system of claim 11, wherein the optical system is an illumination system.

16. The optical system of claim 11, wherein the optical system is a projection objective.

17. An apparatus, comprising:
an illumination system; and
a projection objective,
wherein the illumination system and/or the projection objective comprises an arrangement according to claim 1, and the apparatus is a microlithographic projection exposure apparatus.

18. The apparatus of claim 17, wherein the illumination system comprises an arrangement according to claim 1.

19. The apparatus of claim 17, wherein the projection objective comprises an arrangement according to claim 1.

20. A process, comprising:
using a microlithographic projection exposure apparatus to produce microstructured components,
wherein the microlithographic projection exposure apparatus comprises an illumination system and a projection objective, and the illumination system and/or the projection objective comprises an arrangement according to claim 1.
